(19) United States
(12) Patent Application Publication
(10) Pub. No.: US 2023/0391960 A1
(43) Pub. Date: Dec. 7, 2023

(54) TWO-PART CONDENSATION CURABLE SILICONE COMPOSITIONS AND THEIR APPLICATIONS

(71) Applicant: DOW SILICONES CORPORATION, Midland, MI (US)

(72) Inventor: Frederic GUBBELS, Seneffe (BE)

(21) Appl. No.: 18/036,048

(22) PCT Filed: Nov. 16, 2021
(86) PCT No.: PCT/US2021/059447

§ 371 Date: May 9, 2023

Related U.S. Application Data
(60) Provisional application No. 63/114,731, filed on Nov. 17, 2020.

(51) Int. Cl. C08G 77/58; C08K 5/541

(52) U.S. Cl. CPC C08G 77/58; C08K 5/541

(57) ABSTRACT

Two-part condensation curable silicone compositions and their applications are provided. Also provided is a new titanium-based reaction product, which, because of its incorporation as a catalyst, is able to provide compositions having both improved stability in the presence of water and accelerated cure processes when compared to conventional titanium catalysts. The titanium-based reaction product is obtained or obtainable from a process comprising the steps of: (i) mixing a first ingredient, an alkoxy titanium compound having from 2 to 4 alkoxy groups with a second ingredient, a linear or branched polydiorganosiloxane polymer having at least two terminal silanol groups per molecule; (ii) enabling the first and second ingredients to react together by stirring under vacuum to form a reaction product; and collecting the reaction product of step (ii).

This disclosure relates to two-part condensation curable silicone compositions and their applications which because of the incorporation of a new titanium-based reaction product as a catalyst is able to provide compositions having both improved stability in the presence of water and accelerated cure processes when compared to standard titanium catalysts.

It is well known to those skilled in the art that alkoxy titanium compounds, i.e., alkyl titanates, are suitable catalysts for one component moisture curable silicone compositions (References: Noll, W. Chemistry and Technology of Silicones, Academic Press Inc., New York, 1968, p. 399, and Michael A. Brook, silicon in organic, organometallic and polymer chemistry, John Wiley & sons, Inc. (2000), p. 285). Titanate catalysts have been widely described for their use to formulate skin or diffusion cured one-part condensation curing silicone elastomers. These formulations are typically available in one-part packages that are applied in a layer that is thinner than typically 15 mm. Layers thicker than 15 mm are known to lead to uncured material in the depth of the material, because the moisture is very slow to diffuse in very deep sections. Skin or diffusion cure (e.g., moisture/condensation) takes place by the formation of a cured skin at the composition/air interface subsequent to the sealant/encapsulant being applied on to a substrate surface. Subsequent to the generation of the surface skin the cure speed is dependent on the speed of diffusion of moisture from the sealant/encapsulant interface with air to the inside (or core) of the layer of silicone composition applied, and the diffusion of condensation reaction by-product/effluent from the inside (or core) to the outside (or surface) of the material and the gradual thickening of the cured skin over time from the outside/surface to the inside/core.

Multi-component compositions designed to activate condensation cure in the bulk of e.g., silicone sealant layer until recently have not used titanium-based catalysts. Hence, other catalysts such as tin or zinc-based catalysts, e.g., dibutyl tin dilaurate, tin octoate and/or zinc octoate were generally used (Noll, W. Chemistry and Technology of Silicones, Academic Press Inc., New York, 1968, p. 397). In silicone compositions stored before use in two or more parts, one part contains a filler which typically contains the moisture required to activate condensation cure in the bulk of the product Unlike the previously mentioned diffusion cure one-part system, two-part condensation cure systems, once mixed together, enable bulk cure even in sections greater than 15 mm in depth. In this case the composition will cure (subsequent to mixing) throughout the material bulk. If a skin is formed, it will be only in the first minutes after application. Soon after, the product will become a solid in the entire mass.

Until recently, titanate catalysts i.e. tetra alkyl titanates (e.g. Ti(OR) 4 where R is an alkyl group having at least one carbon) and chelated titanates were not used in or as curing agents for curing two-part condensation curable compositions because it was well known that they are sensitive to hydrolysis (e.g. the cleavage of bonds in functional groups by reaction with water) or alcoholysis in presence of water or alcohol respectively. Unfortunately, titanium compounds of this type quickly react and liberate the corresponding alcohol with respect to the alkoxy group(s) bound to the titanium. For example, in the presence of moisture tetra alkyl titanate catalysts can fully hydrolyse to form titanium (IV) hydroxide (Ti(OH)₄), which is of only limited solubility in silicone-based compositions. Crucially, the formation of titanium hydroxides such as titanium (IV) hydroxide can dramatically negatively affect the catalytic efficiency of the titanium-based compound(s) provided as catalysts for curing condensation curable silicone compositions, leading to uncured or at best only partially cured systems. This issue is not seen with Tin (IV) catalysts because they are not similarly affected by e.g., water contained in the filler present in one of the parts of the product. resulting in the historic understanding that such two-part condensation curable compositions require tin catalysts.

Recently contrary to historical expectations it has been found that in some instances titanium-based catalysts may be utilised in or as curing agents in multi-part, e.g., two-part, compositions designed for condensation “bulk cure” of silicone-based compositions (e.g. WO2016120270, WO2018024858 and WO2019027668). This is helpful to many users because tin cured condensation systems undergo reversion (i.e., depolymerisation) at temperatures above 80° C. and as such the use of tin (IV) catalysts are not desired for several applications especially where cured elastomers are going to be exposed to heat e.g., electronics applications. However, whilst this is a significant benefit, the titanium-based catalysts when used in or as curing agents in said two-part compositions can't match the speed of cure obtained with tin (IV) catalysts.

Hence, there is a need to identify suitable two-part silicone-based compositions using titanate-based catalysts which can at least match the gel time of silicone-based compositions cured using tin (IV) based catalysts.

There is provided herein a two-part condensation curable silicone composition comprising a first part consisting or comprising
(a) a titanium-based reaction product obtained or obtainable from a process comprising the steps of:
   (i) mixing a first ingredient, an alkoxy titanium compound having from 2 to 4 alkoxy groups with a second ingredient, a linear or branched polydiorganosiloxane polymer having at least two terminal silanol groups per molecule;
   (ii) enabling the first and second ingredients to react together by stirring under vacuum to form a reaction product; and
   (iii) collecting the reaction product of step (ii); and
a second part consisting or comprising
(b) one or more silicon containing compounds having at least 2, alternatively at least 3 hydroxyl and/or hydrolysable groups per molecule; and wherein either the first part, or the second part or the first and second parts contains
(c) a source of water comprising water, hydrated reinforcing inorganic filler, hydrated non-reinforcing inorganic filler or a mixture thereof.

There is also provided a process for preparing a two-part condensation curable silicone composition comprising

Providing a first part consisting or comprising of a titanium-based reaction product by preparing said titanium-based reaction product in accordance with the following steps:
(i) mixing a first ingredient, an alkoxy titanium compound having from 2 to 4 alkoxy groups with a second ingredient, a linear or branched polydiorganosiloxane polymer having at least two terminal silanol groups per molecule;
(ii) enabling the first and second ingredients to react together by stirring under vacuum to form a reaction product; and
(iii) collecting the reaction product of step (ii); and
   providing a second part comprising or consisting of
(b) one or more silicon containing compounds having at least 2, alternatively at least 3 hydroxyl and/or hydrolysable groups per molecule; and wherein either the first part, or the second part or the first and second parts contain
(c) a source of water comprising water, hydrated reinforcing inorganic filler, hydrated non-reinforcing inorganic filler or a mixture thereof.

There is also provided a cured material which is the reaction product of the composition as hereinbefore described.

Condensation curable silicone compositions generally comprise a minimum of three ingredients, (i) Silicone polymer, typically for example a molecule analogous to the second ingredient used in the preparation of component (a); (ii) a cross-linker molecule which is designed to cross-link the polymer during the curing process to form a cross-linked network creating a cured gel-like and/or elastomeric material and (iii) a catalyst, e.g. a tin (iv) compound or a titanate as defined as ingredient (i) herein. Depending on the intended end use such compositions may comprise a wide variety of additives which can adjust the properties of the cured material when present.

It is also to be appreciated that component (a), the titanium-based reaction product described herein, not only appears to render the catalytic nature of the titanium molecules more hydrolytically stable (stable to water) but also because the second starting ingredient generally has at least two silanol groups per molecule the reaction product has Si—O—Ti or silanol groups available for reaction into the cured product. Hence, when utilised in or as a curing agent for condensation curable silicone compositions the titanium-based reaction product resulting from the process for the preparation of component (a) may function as both catalyst and at least partially as the silicone polymer.

Component (a), the titanium-based reaction product of the composition herein, is prepared by the reaction of a first and second ingredient. The first ingredient of the process to prepare component (a) is an alkoxy titanium compound having from 2 to 4 alkoxy groups, e.g. Ti(OR)₄, Ti(OR)₃R¹, Ti(OR)₂R¹₂ or a chelated alkoxy titanium molecule where there are two alkoxy (OR) groups present and a chelate bound twice to the titanium atom; where R is a linear or branched alkyl group having from 1 to 20 carbons, alternatively 1 to 15 carbons, alternatively 1 to 10 carbons, alternatively 1 to 6 carbons and when present R¹ is an organic group such as an alkyl group having from 1 to 10 carbon atoms, an alkenyl group having from 2 to 10 carbon atoms, an alkynyl group having from 2 to 10 carbon atoms, a cycloalkyl group having from 3 to 10 carbon atoms, or a phenyl group having from 6 to 20 carbon atoms or a mixture thereof.

Each R¹ may optionally contain substituted groups with e.g., one or more halogen group such as chlorine or fluorine. Examples of R¹ may include but are not restricted to methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group. However, typically each R¹ may be the same or different and is selected from an alkyl group, an alkenyl group or an alkynyl group, alternatively an alkyl group, an alkenyl group, alternatively an alkyl group, in each case having up to 10 carbons, alternatively, up to 6 carbons per group.

As mentioned above R is a linear or branched alkyl group having from 1 to 20 carbons, include but are not restricted to methyl, ethyl, n-propyl, isopropyl, n-butyl, tertiary butyl and branched secondary alkyl groups such as 2, 4-dimethyl-3-pentyl. Suitable examples of the first ingredient when Ti(OR)₄, include for the sake of example, tetra methyl titanate, tetra ethyl titanate, tetra n-propyl titanate, tetra n-butyl titanate, tetra t-butyl titanate, tetraisopropyl titanate. When the first ingredient is Ti(OR)₃R¹, R¹ is typically an alkyl group and examples include but are not limited to trimethoxy alkyl titanium, triethoxy alkyl titanium, tri n-propoxy alkyl titanium, tri n-butoxy alkyl titanium, tri t-butoxy alkyl titanium and tri isopropoxy alkyl titanate.

The first ingredient, used to prepare component (a) of the composition herein, i.e., the alkoxy titanium compound having from 2 to 4 alkoxy groups, maybe present in an amount of from 0.01 wt. % to 20 wt. % of the total weight of the First ingredient+second ingredient.

The second ingredient used to prepare component (a) of the composition herein is a linear or branched polydiorganosiloxane having at least two terminal silanol groups per molecule. The second ingredient used to prepare component (a) of the composition herein may comprise an oligomer or polymer comprising multiple siloxane units of formula (1)

—(R²ₛSiO_{(4-s)/2})— (1)

in which each R 2 is independently an organic group such as a hydrocarbyl group having from 1 to 10 carbon atoms optionally substituted with one or more halogen group such as chlorine or fluorine and s is 0, 1 or 2. In one alternative s is 2 and the linear or branched polydiorganosiloxane backbone is therefore linear although a small proportion of groups where s is 1 may be utilised to enable branching. For example, R 2 may include alkyl groups such as methyl, ethyl, propyl, butyl, alkenyl groups such as vinyl, propenyl, butenyl, pentenyl and or hexenyl groups, cycloalkyl groups such as cyclohexyl, and aromatic groups such as phenyl, tolyl group. In one alternative, R 2 may comprise alkyl groups, alkenyl groups and/or phenyl groups such as methyl, ethyl, propyl, butyl, alkenyl groups such as vinyl, propenyl, butenyl, pentenyl and or hexenyl groups, cycloalkyl groups such as cyclohexyl, and aromatic groups such as phenyl, tolyl group. Preferably, the polydiorganosiloxane chain is a polydialkylsiloxane chain, a polyalkylalkenylsiloxane chain or a polyalkylphenylsiloxane chain but co-polymers of any two or more of these may also be useful. When the second ingredient contains a polydialkylsiloxane chain, a polyalkylalkenylsiloxane chain and/or a polyalkylphenylsiloxane chain the alkyl groups usually comprises between 1 and 6 carbons; alternatively the alkyl groups are methyl and/or ethyl groups, alternatively the alkyl groups are methyl groups; the alkenyl groups usually comprises between 2 and 6 carbons; alternatively the alkenyl groups may be vinyl, propenyl, butenyl, pentenyl and or hexenyl groups, alternatively vinyl, propenyl, and/or hexenyl groups. In one alternative the polydiorganosiloxane is a polydimethylsiloxane chain, a polymethylvinylsiloxane chain or a polymethylphenylsiloxane chain, or a copolymer of two or all of these.

For the avoidance of doubt a polydiorganosiloxane polymer means a substance composed of a molecule of high molecular weight (generally having a nurnber average molecular weight of greater than or equal to 10,0000 g/mol comprising a large number of —(R²ₛSiO_{(4-s)/2})— units which show polymer-like properties and the addition or removal of one or a few of the units has a negligible effect on the properties. In contrast a polydiorganosiloxane oligomer is a compound with a regular repeating structure —(R²ₛ SiO_{(4-s)/2})- units having too low an average molecular weight e.g., a molecule consisting of a few monomer units, e.g., dimers, trimers, and tetramers are, for example, oligomers respectively composed of two, three, and four monomers.

When linear, each terminal group must contain one silanol group. For example, the polydiorganosiloxane maybe dialkylsilanol terminated, alkyl disilanol terminated or trisilanol terminated but is preferably dialkylsilanol terminated. When branched the second ingredient must have at least two terminal silanol (Si—OH) bonds per molecule and as such comprise at least two terminal groups which are dialkylsilanol groups, alkyl disilanol groups and/or trisilanol groups, but typically dialkylsilanol groups.

Typically the second ingredient used to prepare component (a) of the composition herein, will have a viscosity in the order of 30 to 300 000 mPa·s, alternatively 50 to 100 000 mPa·s at 25° C., alternatively 70 to 75,000 mPa·s at 25° C., alternatively 70 to 50,000 mPa·s at 25° C., alternatively 70 to 20,000 mPa·s at 25° C., alternatively 70 to 10,000 mPa·s at 25° C. The viscosity may be measured using any suitable means e.g., a Modular Compact Rheometer (MCR) 302 Anton Paar GmbH of Graz, Austria using the most suitable settings and plates for the viscosity concerned, for example using a 25 mm diameter rotational plate with a gap of 0.3 mm at a shear rate of 1s⁻¹.

The number average molecular weight (Mn) and weight average molecular weight (Mw) of silicone can also be determined by Gel permeation chromatography (GPC) using polystyrene calibration standards. This technique is a standard technique, and yields values for Mw (weight average), Mn (number average) and polydispersity index (PI) (where PI=Mw/Mn).

Mn value provided in this application have been determined by GPC and represent a typical value of the polydiorganosiloxane used. If not provided by GPC, the Mn may also be obtained from calculation based on the dynamic viscosity of said polydiorganosiloxane.

The reaction used to prepare component (a) of the composition herein, may be undertaken at any suitable temperature but typically commences at room temperature. The temperature may elevate during the reaction and/or stirring and if desired the ingredients may be heated during the reaction.

The reaction used to prepare component (a) of the composition herein takes place under vacuum with a view to removing at least 50 wt. %, alternatively at least 75 wt. % alternatively at least 90% of the total amount of alcoholic by-products generated during the reaction. The above may be determined via several analytical techniques of which the simplest is the determination of weight loss from the reaction product.

Without being tied to current understanding, it is believed that the main reaction products of the above reaction when the first ingredient is Ti(OR)₄, is a mixture of

(RO)ₙTi((OSiR²₂)ₘ—OH)₄₋ₙ (2)

Where n is 0, 1 or 2, alternatively 0 or 1, but preferably the major product is where n is 0, i.e.

Ti((OSiR²₂)ₘ—OH)₄ (3)

Where m is the degree of polymerisation of the second ingredient and is an integer indicative (commensurate) of the viscosity thereof.

Similarly when the first ingredient is substantially Ti(OR)₃R¹ it is believed that the main reaction products of the above reaction when a is 0 or 1, is

R¹(RO)ₐTi((OSiR²₂)ₘ—OH)₃₋ₐ (4)

but preferably the major product is where a is 0, i.e.

R¹Ti((OSiR²₂)ₘ—OH)₃ (5)

Where m is the degree of polymerisation of the second ingredient and is an integer indicative (commensurate) of the viscosity of the second ingredient.

Optionally, there may be a third ingredient used in the preparation of component (a) of the composition herein. When present, the third ingredient is a linear or branched polydiorganosiloxane and may be an oligomer or polymer as described for the second ingredient. However, the third ingredient only has one terminal silanol group per molecule for use in the reaction described above to form a Si—O—Ti bond with the first ingredient. The other terminal group(s) of the third ingredient contain no silanol groups. The terminal groups containing no silanol groups may comprise R² groups as defined above, alternatively a mixture of alkyl and alkenyl R² groups, alternatively alkyl R² groups. Examples include trialkyl termination e.g., trimethyl or triethyl termination or dialkylalkenyl termination, e.g., dimethylvinyl or diethyl vinyl or methylethylvinyl termination or the like.

Typically the third ingredient used in the preparation of component (a) of the composition herein will also have a viscosity analogous to that of the second ingredient, in the order of 30 to 300 000 mPa·s, alternatively 50 to 100 000 mPa·s at 25° C., alternatively 70 to 75,000 mPa·s at 25° C., alternatively 70 to 50,000 mPa·s at 25° C., alternatively 70 to 20,000 mPa·s at 25° C., alternatively 70 to 10,000 mPa·s at 25° C. The viscosity may be measured using any suitable means e.g., a Modular Compact Rheometer (MCR) 302 Anton Paar GmbH of Graz, Austria using the most suitable settings and plates for the viscosity concerned, for example using a 25 mm diameter rotational plate with a gap of 0.3 mm at a shear rate of 1s⁻¹.

The third ingredient may be present in an amount of up to 75 wt. % of the combination of the weight of the first, second and third ingredients, whereby the third ingredient replaces the equivalent proportion of the second ingredient. However, preferably the third ingredient when present is present in an amount of no more than 50%, alternatively no more than 25% of the first, second and third ingredients. When the third ingredient is present one or more silanol groups in structures (2), (3), (4) or (5) may be replaced by an R² group, alternatively an alkyl group or an alkenyl group, alternatively an alkyl group. For example, in the case of structure (2) the reaction product may be that shown below in structure (2a):

(RO)ₙTi((OSiR²₂)ₘ—R²)ₚ((OSiR²₂)ₘ—OH)₄₋ₙ₋ₒ (2a)

Where n is 0, 1 or 2, alternatively 0 or 1, p is 0, 1 or 2, alternatively 0 or 1, and n+p is less than or equal to 4 and m is as previously defined.

It is preferred not to include the third ingredient as a reactant in the preparation of component (a) of the composition herein as when catalysts of the type depicted in structures (2), (3), (4) or (5) are present the terminal silanol groups are potentially available for participation in the formation of the cured silicone network, which makes them useful in the fully formulated elastomers. This is clearly less likely to be the case when greater amounts of the third ingredient are used as a starting ingredient in the process to make the titanium-based reaction product which can be used as component (a) in the compositions described herein. However, the presence of some of the third ingredient in the starting materials may be useful to assist in obtaining the required modulus of elastomers cured using the product of the process described herein.

When the starting ingredients in the process used for the preparation of component (a) of the composition herein are the first and second ingredients, the molar ratio of silanol groups:titanium may be any suitable ratio equal to or greater than 2:1. However, it is preferred for the ratio to be within the range of from 5:1 to 15:1 alternatively from 7:1 to 15:1, alternatively from at least 8:1 to 11:1. Lower ratios seem to lead to the presence of more viscous reaction product and less first ingredient present resulting in slower gelling times.

The total silanol molar content is calculated for 100 g of first and second ingredients. The silanol molar content related to the second ingredient is equal to the amount in grams (g) of silanol containing polymer in 100 g of the first and second ingredients divided by the number average molecular weight of the second ingredient multiplied by the average number of silanol functions present in the second ingredient, typically 2. If there are several silanol functional linear or branched polydiorganosiloxanes in the starting ingredients, the sum of the molar content of each polymer is determined and then the cumulative total from all the linear or branched polydiorganosiloxanesis added together to constitute the total silanol molar content in the formulation.

The molar amount of any starting ingredient was determined using the following calculation:

[Weight in parts of the ingredient×100]

[sum of all parts of the starting ingredients×MW of the ingredient]

Hence, merely for example, when ingredient 1 is tetra n-butyl titanate (TnBT), if ingredient 1 and ingredient 2 were mixed in a weight ratio of 10:1, i.e., 10 parts of ingredient 2 to every one part by weight of ingredient 1, given the molecular weight of TnBT is 340; the calculation would be.

[Weight in parts of TnBT (1)×100]

[sum of all parts of the starting ingredients (11)×340]=0.0267 mole of catalyst per 100 g of the composition.

In one embodiment of the process used in the preparation of component (a) of the composition herein, the first ingredient is added to the second ingredient, or when the third ingredient is present, the first ingredient is added to a mixture of the second and third ingredients.

In an alternative embodiment used in the preparation of component (a) of the composition herein, the second ingredient may be introduced into the first ingredient. This embodiment is less convenient than the above because titanates of the type used as the first ingredient, from which volatile alcohols (R—OH) are generated in accordance with chemical reactions (6) below, are generally flammable due to the moisture from environment because it will substantially always contain some alcohol residues. The flash point of the titanium catalyst depends on the alcohol flammability.

Ti-OR+H₂O(moisture from the air)->Ti-OH+R—OH

Ti-OR+Si—OH->Ti—O—Si+R—OH (6)

Hence, this method will require an explosion proof manufacturing process and the second ingredient is introduced into the first ingredient in a gradual measured manner. This route is likely to lead, at least initially, to a more concentrated catalyst until gradually the content of the second ingredient is increased. This embodiment is also less favoured because it is more difficult to remove the alcoholic by-products as successfully and the content of the second ingredient is generally much larger than the first ingredient in weight and volume.

It was found however that there was no need for complicated separation techniques to be used to isolate specific titanium species as component (a) of the composition as the reaction product works very well without separation.

Component (b) of the two-part condensation curable silicone composition is one or more silicon containing compounds having at least 2, alternatively at least 3 hydroxyl and/or hydrolysable groups per molecule. Component (b) is effectively functioning as a cross-linker and as such requires a minimum of 2 hydrolysable groups per molecule and preferably 3 or more. In some instances, component (b) may be considered as a chain extender, i.e., when component (a) the titanium-based reaction product only has one or two chemically available silanol groups but can be used as a cross-linker if component (a) the titanium-based reaction product has 3 or more reactive groups per molecule, which in this instance is typically anticipated to be the norm. Component (b) may thus have two but alternatively has three or more silicon-bonded condensable (preferably hydroxyl and/or hydrolysable) groups per molecule which are reactive with the silanol groups in component (a).

In one embodiment, component (b) of the composition herein is an organopolysiloxane polymer having at least two hydroxyl or hydrolysable groups per molecule of the formula

X_{3-n′}R³_{n′}Si—(Z)_{d}—(O)_{q}—(R⁴_{y}SiO_{4-y(/2})_{z}—(SiR⁴₂-Z)_{d}—Si—R³_{n′}X_{3-n′} (7)

in which each X is independently a hydroxyl group or a hydrolysable group, each R³ is an alkyl, alkenyl or aryl group, each R⁴ is X group, alkyl group, alkenyl group or aryl group and Z is a divalent organic group;
d is 0 or 1, q is 0 or 1 and d+q=1; n′ is 0, 1, 2 or 3, y is 0, 1 or 2, and preferentially 2 and z is an integer such that said organopolysiloxane polymer has a viscosity of from 50 to 150,000 mPa·s at alternatively 50 to 100 000 mPa·s at 25° C., alternatively 70 to 75,000 mPa·s at 25° C., alternatively 70 to 50,000 mPa·s at 25° C., alternatively 70 to 20,000 mPa·s at 25° C., alternatively 70 to 10,000 mPa·s at 25° C. The value of z is therefore an integer enabling (commensurate with) such a viscosity, alternatively z is an integer from 100 to 5000. Whilst y is 0, 1 or 2, substantially y=2, e.g., at least 90% alternatively 95% of R⁴_{y}SiO_{(4-y)/2}) groups are characterized with y=2. The viscosity may be measured using any suitable means e.g., a Modular Compact Rheometer (MCR) 302 from Anton Paar GmbH of Graz, Austria using the most suitable settings and plates for the viscosity concerned, for example using a 25 mm diameter rotational plate with a gap of 0.3 mm at a shear rate of 1s⁻¹.

Each X group of components (b) when an organopolysiloxane polymer may be the same or different and can be a hydroxyl group or a condensable or hydrolyzable group. The term “hydrolyzable group” means any group attached to the silicon, which is hydrolyzed by water at room temperature. The hydrolyzable group X includes groups of the formula-OT, where T is an alkyl group such as methyl, ethyl, isopropyl, octadecyl, an alkenyl group such as allyl, hexenyl, acetyl groups, cyclic groups such as cyclohexyl, phenyl, benzyl, beta-phenylethyl; hydrocarbon ether groups, such as 2-methoxyethyl, 2-ethoxyisopropyl, 2-butoxyisobutyl, p-methoxyphenyl or —(CH₂CH₂O)₂CH₃.

The most preferred X groups are hydroxyl groups or alkoxy groups. Illustrative alkoxy groups are methoxy, ethoxy, propoxy, isopropoxy, butoxy, isobutoxy, pentoxy, hexoxy octadecyloxy and 2-ethylhexoxy; dialkoxy groups, such as methoxymethoxy or ethoxymethoxy and alkoxyaryloxy, such as ethoxyphenoxy. The most preferred alkoxy groups are methoxy or ethoxy. When d=1, n′ is typically 0 or 1 and each X is an alkoxy group, alternatively an alkoxy group having from 1 to 3 carbons, alternatively a methoxy or ethoxy group. In such a case component (b) when an organopolysiloxane polymer has the following structure:

X_{3-n′}R³_{n′}Si—(Z)—(R⁴_{y}SiO_{(4-y)/2})_{z}—(SiR⁴₂—Z)—Si—R³_{n′}X_{3-n′}

with R³, R⁴, Z, y and z being the same as previously identified above, n′ being 0 or 1 and each X being an alkoxy group.

Each R³ is individually selected from alkyl groups, alternatively alkyl groups having from 1 to 10 carbon atoms, alternatively from 1 to 6 carbon atoms, alternatively 1 to 4 carbon atoms, alternatively methyl or ethyl groups; alkenyl groups alternatively alkenyl groups having from 2 to carbon atoms, alternatively from 2 to 6 carbon atoms such as vinyl, allyl and hexenyl groups; aromatic groups, alternatively aromatic groups having from 6 to 20 carbon atoms, substituted aliphatic organic groups such as 3,3,3-trifluoropropyl groups aminoalkyl groups, polyaminoalkyl groups, and/or epoxyalkyl groups.

Each R⁴ is individually selected from the group consisting of X or R³ with the proviso that cumulatively at least two X groups and/or R⁴ groups per molecule are hydroxyl or hydrolysable groups. It is possible that some R⁴ groups may be siloxane branches off the polymer backbone which branches may have terminal groups as hereinbefore described. Most preferred R⁴ is methyl.

Each Z is independently selected from an alkylene group having from 1 to 10 carbon atoms. In one alternative each Z is independently selected from an alkylene group having from 2 to 6 carbon atoms; in a further alternative each Z is independently selected from an alkylene group having from 2 to 4 carbon atoms. Each alkylene group may for example be individually selected from an ethylene, propylene, butylene, pentylene and/or hexylene group.

Additionally n′ is 0, 1, 2 or 3, d is 0 or 1, q is 0 or 1 and d+q=1. In one alternatively when q is 1, n′ is 1 or 2 and each X is an OH group or an alkoxy group. In another alternative when d is 1 n′ is 0 or 1 and each X is an alkoxy group.

Component (b) when an organopolysiloxane polymer can be a single siloxane represented by Formula (7) or it can be mixtures of organopolysiloxane polymers represented by the aforesaid formula. Hence, the term “siloxane polymer mixture” in respect to component (b) when an organopolysiloxane polymer is meant to include any individual organopolysiloxane polymer or mixtures of organopolysiloxane polymer.

The Degree of Polymerization (DP), (i.e., in the above formula substantially z), is usually defined as the number of monomeric units in a macromolecule or polymer or oligomer molecule of silicone. Synthetic polymers invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer can be determined by Gel permeation chromatography (GPC) using polystyrene calibration standards. with precision of about 10-15%. This technique is standard and yields Mw, Mn and polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity.

When component (b) of the two-part condensation curable silicone composition is an organopolysiloxane polymer as described above, it may be present in the composition in an amount of from 1 to 95% by weight of the composition, alternatively 35 to 55%, alternatively 40 to 55% by weight of the composition.

In an alternative embodiment component (b) may be
silanes having at least 2 hydrolysable groups, alternatively at least 3 hydrolysable groups per molecule group; and/or
silyl functional molecules having at least 2 silyl groups, each silyl group containing at least one hydrolysable group.

For the sake of the disclosure herein silyl functional molecule is a silyl functional molecule containing two or more silyl groups, each silyl group containing at least one hydrolysable group. Hence, a disilyl functional molecule comprises two silicon atoms each having at least one hydrolysable group, where the silicon atoms are separated by an organic chain or a siloxane chain not described above. Typically, the silyl groups on the disilyl functional molecule may be terminal groups. The spacer may be a polymeric chain.

The hydrolysable groups on the silyl groups include acyloxy groups (for example, acetoxy, octanoyloxy, and benzoyloxy groups); ketoximino groups (for example dimethyl ketoximo, and isobutylketoximino); alkoxy groups (for example methoxy, ethoxy, and propoxy) and alkenyloxy groups (for example isopropenyloxy and 1-ethyl-2-methylvinyloxy). In some instances, the hydrolysable group may include hydroxyl groups.

When component (b) is a silane, said silanes may include alkoxy functional silanes, oximosilanes, acetoxy silanes, acetonoxime silanes and/or enoxy silanes.

When component (b) is a silane and when the silane has only three silicon-bonded hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. The fourth silicon-bonded organic groups may be methyl.

A typical silane may be described by formula (8)

R″₄₋ᵣSi(OR⁵)ᵣ (8)

wherein R⁵ is described above and r has a value of 2, 3 or 4. Typical silanes are those wherein R″ represents methyl, ethyl or vinyl or isobutyl. R″ is an organic radical selected from linear and branched alkyls, allyls, phenyl and substituted phenyls, acetoxy, oxime. In some instances, R⁵ represents methyl or ethyl and r is 3.

Another type of suitable silanes for component (b) are molecules of the type Si(OR 5)₄ where R⁵ is as described above, alternatively propyl, ethyl or methyl. Partial condensates of Si(OR 5)₄ may also be considered.

In a further embodiment component (b) is a silyl functional molecule having at least 2 silyl groups each having at least 1 and up to 3 hydrolysable groups, alternatively each silyl group has at least 2 hydrolysable groups.

Component (b) may be a disilyl functional polymer, that is, a polymer containing two silyl groups, each containing at least one hydrolysable group such as described by the formula (4)

(R⁶O)_{m′}(Y¹)_{3-m′}—Si(CH₂)ₓ—((NHCH₂CH₂)ₜ-Q(CH₂)ₓ)_{n″}—Si(OR⁶)_{m′}(Y¹)_{3-m′} (4)

where R⁶ is a C₁₋₁₀ alkyl group, Y¹ is an alkyl groups containing from 1 to 8 carbons, Q is a chemical group containing a heteroatom with a lone pair of electrons e.g., an amine, N-alkylamine or urea; each x is an integer of from 1 to 6, t is 0 or 1; each m′ is independently 1, 2 or 3 and n″ is 0 or 1.

When component (b) is a disilyl functional polymer, the polymer may have an organic polymeric backbone. The polymeric backbone of a silyl (e.g., disilyl) functional component (b) may be organic, i.e., component (b) may comprise organic based polymers with silyl terminal groups e.g., silyl polyethers, silyl acrylates and silyl terminated polyisobutylenes. In the case of silyl polyethers the polymer chain is based on polyoxyalkylene based units. Such polyoxyalkylene units preferably comprise a linear predominantly oxyalkylene polymer comprised of recurring oxyalkylene units, (—CₙH₂ₙ—O—) illustrated by the average formula (—C_{n′″}H_{2n′″}—O—)_{y} wherein n is an integer from 2 to 4 inclusive and y is an integer of at least four. Likewise, the viscosity will be ≤1000 at 25° C. mPa·s, alternatively 250 to 1000 mPa·s at 25° C. alternatively 250 to 750 mPa·s at 25° C. and will have a suitable number average molecular weight of each polyoxyalkylene polymer block present. The viscosity may be measured using any suitable means e.g., a Modular Compact Rheometer (MCR) 302 from Anton Paar GmbH of Graz, Austria using the most suitable settings and plates for the viscosity concerned, for example using a 25 mm diameter rotational plate with a gap of 0.3 mm at a shear rate of 1s⁻¹. Moreover, the oxyalkylene units are not necessarily identical throughout the polyoxyalkylene monomer but can differ from unit to unit. A polyoxyalkylene block or polymer, for example, can be comprised of oxyethylene units, (—C₂H₄—O—); oxypropylene units (—C₃H₆—O—); or oxybutylene units, (—C₄H₈—O—); or mixtures thereof.

Other polyoxyalkylene units may include for example: units of the structure

-[—R^{e}—O—(—R^{f}—O—)_{w}-Pn-CR^{g}₂-Pn-O—(—R^{f}—O—)_{q}—R^{e}]—

in which Pn is a 1,4-phenylene group, each R^{e} is the same or different and is a divalent hydrocarbon group having 2 to 8 carbon atoms, each R f is the same or different and, is, an ethylene group or propylene group, each R^{g} is the same or different and is, a hydrogen atom or methyl group and each of the subscripts w and q is a positive integer in the range from 3 to 30.

For the purpose of this application “Substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

In the case of such organic based cross-linkers the molecular structure can be straight chained, branched, cyclic or macromolecular, i.e., an organic polymer chain bearing alkoxy functional end groups.

Whilst any suitable hydrolysable groups may be utilised, it is preferred that the hydrolysable groups are alkoxy groups and as such the terminal silyl groups may have the formula such as —R^{a}Si(OR^{b})₂, —Si(OR^{b})₃, —R^{a}₂SiOR^{b} or —(R^{a})₂Si—R^{c}—SiR^{d}ₚ (OR^{b})₃₋ₚ where each R^{a} independently represents a monovalent hydrocarbyl group, for example, an alkyl group, in particular having from 1 to 8 carbon atoms, (and is preferably methyl); each R^{b} and R^{d} group is independently an alkyl group having up to 6 carbon atoms; R^{c} is a divalent hydrocarbon group which may be interrupted by one or more siloxane spacers having up to six silicon atoms; and p has the value 0, 1 or 2. Typically each terminal silyl group will have 2 or 3 alkoxy groups.

Component (b) thus include alkyltrialkoxysilanes such as methyltrimethoxysilane (MTM) and methyltriethoxysilane, tetraethoxysilane, partially condensed tetraethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate, dimethyltetraacetoxydisiloxane, oximosilanes, acetoxy silanes, acetonoxime silanes, enoxy silanes and other such trifunctional alkoxysilanes as well as partial hydrolytic condensation products thereof; 1,6-bis (trimethoxysilyl)hexane (alternatively known as hexamethoxydisilylhexane), bis (trialkoxysilylalkyl)amines, bis (dialkoxyalkylsilylalkyl)amine, bis (trialkoxysilylalkyl)N-alkylamine, bis (dialkoxyalkylsilylalkyl) N-alkylamine, bis (trialkoxysilylalkyl)urea, bis (dialkoxyalkylsilylalkyl) urea, bis (3-trimethoxysilylpropyl)amine, bis (3-triethoxysilylpropyl)amine, bis (4-trimethoxysilylbutyl)amine, bis (4-triethoxysilylbutyl)amine, bis (3-trimethoxysilylpropyl)N-methylamine, bis (3-triethoxysilylpropyl)N-methylamine, bis (4-trimethoxysilylbutyl)N-methylamine, bis (4-triethoxysilylbutyl)N-methylamine, bis (3-trimethoxysilylpropyl)urea, bis (3-triethoxysilylpropyl)urea, bis (4-trimethoxysilylbutyl)urea, bis (4-triethoxysilylbutyl)urea, bis (3-dimethoxymethylsilylpropyl)amine, bis (3-diethoxymethyl silylpropyl)amine, bis (4-dimethoxymethylsilylbutyl)amine, bis (4-diethoxymethyl silylbutyl)amine, bis (3-dimethoxymethylsilylpropyl)N-methylamine, bis (3-diethoxymethyl silylpropyl)N-methylamine, bis (4-dimethoxymethylsilylbutyl)N-methylamine, bis (4-diethoxymethyl silylbutyl)N-methylamine, bis (3-dimethoxymethylsilylpropyl)urea, bis (3-diethoxymethyl silylpropyl)urea, bis (4-dimethoxymethylsilylbutyl)urea, bis (4-diethoxymethyl silylbutyl)urea, bis (3-dimethoxyethylsilylpropyl)amine, bis (3-diethoxyethyl silylpropyl)amine, bis (4-dimethoxyethylsilylbutyl)amine, bis (4-diethoxyethyl silylbutyl)amine, bis (3-dimethoxyethylsilylpropyl)N-methylamine, bis (3-diethoxyethyl silylpropyl)N-methylamine, bis (4-dimethoxyethylsilylbutyl)N-methylamine, bis (4-diethoxyethyl silylbutyl)N-methylamine, bis (3-dimethoxyethylsilylpropyl)urea bis (3-diethoxyethyl silylpropyl)urea, bis (4-dimethoxyethylsilylbutyl)urea and/or bis (4-diethoxyethyl silylbutyl)urea; bis (triethoxysilylpropyl)amine, bis (trimethoxysilylpropyl)amine, bis (trimethoxysilylpropyl)urea, bis (triethoxysilylpropyl)urea, bis (diethoxymethylsilylpropyl)N-methylamine; di or trialkoxy silyl terminated polydialkyl siloxane, di or trialkoxy silyl terminated polyarylalkyl siloxanes, di or trialkoxy silyl terminated polypropyleneoxide, polyurethane, polyacrylates; polyisobutylenes; di or triacetoxy silyl terminated polydialkyl; polyarylalkyl siloxane; di or trioximino silyl terminated polydialkyl; polyarylalkyl siloxane; di or triacetonoxy terminated polydialkyl or polyarylalkyl. The component (b) used may also comprise any combination of two or more of the above.

When component (b) is one or more silanes or silyl functional molecules as described above they may be present in the composition in an amount of from 1 to 25 wt. % of the composition.

Preferably component (b) is titanium free.

Component (c) of the composition is a source of water comprising water, hydrated reinforcing inorganic filler, hydrated non-reinforcing inorganic filler or a mixture thereof.

In the absence of filler the source of water may be water itself, preferably distilled water. Alternatively, in a filled composition, hydrated reinforcing inorganic filler(s) and/or hydrated non-reinforcing inorganic filler(s) present may be the source of water in the composition. In a further alternative the source of water may be a mixture of water introduced into the composition and water contained in the hydrated filler(s). For the avoidance of doubt fillers containing water herein shall be referred to as hydrated fillers and fillers considered to not contain water shall be referred to as anhydrous fillers. Furthermore, for the avoidance of doubt moisture as hereinbefore described means water.

The amount of water (moisture) present in the filler(s) may be determined in accordance with ISO 787-2:1981 by weighing the filler, drying the filler and noting the difference, determining the % moisture content, which is calculated using the following equation

Moisture content(%)=100×(original weight of filler−dried weight of filler)/original weight of the filler.

For the avoidance of doubt, it should be understood that:
the number of moles of moisture is =the number of moles of water, and
the number of moles of moisture per 100 g of starting filler material is
(Moisture content (%)×18), from which the amount of moisture/water present in filler added into the composition may be determined based on the weight of filler used in the composition.

When component (c) of the composition consists or comprises hydrated filler, the hydrated filler maybe one or more reinforcing fillers or one or more non-reinforcing fillers or a combination of both. For example, hydrated filler may contain one or more finely divided, reinforcing fillers such as precipitated calcium carbonate, ground calcium carbonate, fumed silica, colloidal silica and/or precipitated silica. Typically, the surface area of hydrated reinforcing filler is at least 15 m²/g in the case of precipitated calcium carbonate measured in accordance with the BET method in accordance with ISO 9277:2010, alternatively 15 to 50 m²/g, alternatively, 15 to 25 m²/g. Hydrated silica reinforcing fillers have a typical surface area of at least 50 m²/g. The hydrated silica filler may be precipitated silica and/or fumed silica. In the case of high surface area fumed silica and/or high surface area precipitated silica, these may have surface areas of from 75 to 450 m²/g measured using the BET method in accordance with ISO 9277: 2010, alternatively of from 100 to 400 m²/g using the BET method in accordance with ISO 9277: 2010.

Typically, the hydrated fillers are present in the composition in an amount of from about 5 to 45 wt. % of the composition, alternatively from about 5 to 30 wt. % of the composition, alternatively from about 5 to 25 wt. % of the composition, depending on the chosen filler.

The hydrated reinforcing filler may be hydrophobically treated, for example, with one or more aliphatic acids, e.g. a fatty acid such as stearic acid or a fatty acid ester such as a stearate, or with organosilanes, organosiloxanes, or organosilazanes hexaalkyl disilazane or short chain siloxane diols to render the hydrated reinforcing filler(s) hydrophobic and therefore easier to handle and obtain a homogeneous mixture with the other adhesive components. The surface treatment of the fillers makes them easily wetted by components (a) and (b) when the latter is present. These surface modified fillers do not clump and can be homogeneously incorporated into the components (a) and/or (b). This results in improved room temperature mechanical properties of the uncured compositions. The fillers may be pre-treated or may be treated in situ when being mixed with components (a) and/or (b).

The two-part condensation curable silicone composition is stored before use in two-parts to prevent premature cure. Reaction product (a) is present in one part, often referred to as part A and component (b) in the other part, often referred to as part B. The part A composition in a standard composition may comprise a polymer and a catalyst but as previously discussed the titanium-based reaction product herein effectively functions as both polymer and catalyst. If a polymer having silanol or hydrolysable end-groups were present in part A with a source of water part A would cure. If components (a) and (b) are retained before use in separate parts then component (c) may

be present in the part A composition and/or the part B composition. In our view, it is particularly surprising that a source of water can be included in the part A composition with component (a) as if present with a standard titanate catalyst the titanate would be hydrolysed and effectively catalytically inactivated. However, water does not appear to inactivate component (a) herein, certainly not to any significant extent and cured products are generated when parts A and B are mixed together irrespective of which part contains component (c) the source of water.

Furthermore, it can also be seen that not only is component (a) seemingly resistant to hydrolysis it can be seen to cure the composition when part A and part B are mixed together much faster than do standard titanate catalysts such as tetra isopropyl titanate (TiPT) as can be seen in the following examples. Not only that but the non-flow time and gel time results in the following examples indicate that their curing function results in compositions curing as fast if not faster than compositions cured with tin (IV) catalysts. This is particularly advantageous as titanium cured products will not undergo reversion at temperatures above 80° C. The amount of component (c) present when component (c) is water, in molar terms may be any suitable amount but preferably the is in a ratio of 0.3:1 to 1:1 with respect to the molar content of hydrolysable groups. The water may be present in part A or part B or may be present in part A and part B as desired.

The two-parts can be mixed in any suitable weight ratio. In the present compositions this may be dependent on the type of compound being used as component (b). When component (b) is a polymer the part A: part B weight ratio when mixed will typically tend towards a 1:1 weight ratio, whereas if the component (b) is a smaller compound such as a silane the weight ratio will be less equal. Hence such weight ratios may tend to be between 15:1 to 1:1, alternatively between 10:1 to 1:1, alternatively 5:1 to 1:1. However, the weight ratio of the mixture can be varied to reach the desired modulus after cure.

The composition as hereinbefore described may comprise a variety of additives dependent on the intended end use of the composition. The additives will depend on the intended end use and may include, but are not limited to, anhydrous fillers, adhesion promoters, flux agents, rheological additives, acid acceptors, electrically and thermally conductive additives, salts, dyes, perfumes, preservatives, plasticizers, active ingredients, colorants, labeling agents, rust inhibitors, anti-microbial compounds, detergents water phase stabilizing agents, pH controlling agents, pigments, colorants, UV absorbers, sunscreen agents, dyes, fragrances or perfume, antioxidants, soil release agents, oxidizing agents, reducing agents, propellant gases, dispersibility aids, inorganic salts, antibacterial agents, antifungal agents, bleaching agents, sequestering agents, enzymes, diluents and mixtures thereof.

Anhydrous reinforcing and/or anhydrous extending fillers may include e.g., precipitated and ground silica, precipitated and ground calcium carbonate, treated silicas, glass beads, carbon black, graphite, carbon nanotubes, quartz, talc, titanium dioxide, aluminium oxides, aluminium trihydroxide, chopped fibre such as chopped KEVLAR™, or a combination thereof.

### Adhesion Promoter

Suitable adhesion promoters may comprise alkoxysilanes of the formula R¹⁴ₕ Si(OR¹⁵)₄₋ₕ₎ where subscript h is 1, 2, or 3, alternatively h is 3. Each R¹⁴ is independently a monovalent organofunctional group. R¹⁴ can be an epoxy functional group such as glycidoxypropyl or (epoxycyclohexyl)ethyl, an amino functional group such as aminoethylaminopropyl or aminopropyl, a methacryloxypropyl, a mercapto functional group such as mercaptopropyl or an unsaturated organic group. Each R¹⁵ is independently an unsubstituted, saturated hydrocarbon group of at least 1 carbon atom. R¹⁵ may have 1 to 4 carbon atoms, alternatively 1 to 2 carbon atoms. R¹⁵ is exemplified by methyl, ethyl, n-propyl, and iso-propyl. When present adhesion promoters will be present in an amount of from 0.01% to 2 wt. %, alternatively 0.05 to 2 wt. %, alternatively 0.1 to 1 wt. % of adhesion promoter based on the weight of the total composition when mixed. When present the hydrolysable (alkoxy groups of the adhesion promoter will be included in in the calculations when determining the ratios hereinbefore described.

Examples of suitable adhesion promoters include glycidoxypropyltrimethoxysilane and a combination of glycidoxypropyltrimethoxysilane with an aluminium chelate or zirconium chelate. Examples of adhesion promoters may be found in U.S. Pat. Nos. 4,087,585 and 5,194,649. Preferably, the speed of hydrolysis of the adhesion promoter should be lower than the speed of hydrolysis of the cross-linker in order to favour diffusion of the molecule towards the substrate rather than its incorporation in the product network.

Suitable surfactants include silicone polyethers, ethylene oxide polymers, propylene oxide polymers, copolymers of ethylene oxide and propylene oxide, other non-ionic surfactants, and combinations thereof. The composition may comprise up to 0.05% of the surfactant based on the weight of the composition.

There is also provided herein a method of making the material as hereinbefore described whereby the aforementioned two-parts of the composition are intermixed and cured. Subsequent to intermixing in one embodiment the condensation curable material composition may be applied on to a substrate using a suitable dispenser such as for example curtain coaters, spray devices die coaters, dip coaters, extrusion coaters, knife coaters and screen coaters which upon cure material provides a coating on said substrate.

The product of the composition as hereinbefore described may be utilised for formulating sealants, adhesives, e.g. structural adhesives and pressure sensitive adhesives, encapsulants, pottants, coatings, pressure sensitive adhesives, cured articles for use in construction applications e.g. glass lamination and spacer for glass, automotive applications, e.g. tire sealants for self-sealing tires, electronics applications, e.g. electrically conductive materials, crystal clear materials for LEDs, pottants for solar, electronics and optical devices. displays and optical applications, solar applications, e.g., solar encapsulants, personal care e.g., hair care, skin care and health care applications.

For example, in the case of electronic applications, any suitable electrical or electronic part may be sealed with the cured material as described above but because the cured material herein can suppress the occurrence of air bubbles and cracks and exhibits good bonding to electrical or electronic parts even under high-temperature conditions, it can be advantageously used in power devices used under high-temperature conditions, particularly power devices such as a motor control, a motor control for transport, a power generation system, or a space transportation system. Such products are useful as pottant for electronics to mitigate the impact of thermal cycles on the sensitive components.

Furthermore because the cured material of the present invention has a certain degree of cold resistance in addition to the heat resistance demanded in an Si—C semiconductor chip (for example, heat resistance of 180° C. or above). The electronic article can be a power module, e.g., one of more of the aforementioned devices for power converters, inverters, boosters, traction controls, industrial motor controls, power distribution and transportation systems, especially in power devices that demand the ability to withstand sharp temperature differences and can improve the durability and reliability of such power devices. It may be designed for use in optical applications and electronics applications, including both microelectronics and macroelectronics applications as well as optoelectronics applications and thermally conductive electronics applications, such as making thermally conductive adhesives. Furthermore, the cured material of the present invention may be transparent and therefore may be potentially suitable for use as an encapsulant for light guides e.g., those used to make an optoelectronic device comprising the light guide and at least one light element. The optoelectronic device may comprise at least one light element and a free-standing light guide e.g., a composite light guide configured to transmit light when light is emitted from one or more light elements.

The cured material herein may function as an optical encapsulant for encapsulating the at least one light element. The light guide might also include a lens for controlling direction of light being emitted from the at least one light element, at least one electrical connector for conducting electricity to the at least one light element, or any combination of two or more or all of the preceding additional elements.

The electrical connector(s) independently may be a wire, tabbing, or ribbon and may be made of a highly conductive metal such as Cu, Au, Ag, and alloys thereof. Such optoelectronic devices may be used to make luminaires (devices having at least one light element that is a light-generating element). The luminaire may comprise an optoelectronic device of any one of the preceding embodiments and a power supply for powering the at least one light element. The luminaire may further comprise a lens for controlling direction of light being emitted from the at least one light element, at least one electrical connector for conducting electricity to the at least one light element.

The power supply may be in operative electrical communication with the at least one light element via electrical connector(s). Each of the above light emitting devices may be a light-emitting diode (LED), a liquid crystal display (LCD), or any other light source. In the absence of filler, the composition as described herein is transparent and/or optically clear and as such is particularly suitable for protecting LED and/or LCD lighting from the environment.

Electrically conductive materials, crystal clear materials for LEDs, Displays and optical applications, Structural adhesive, PSA adhesives etc.

In the case of adhesives, cured silicone materials prepared from a material composition as hereinbefore described may adhere to various substrates such as electrical or electronic components and/or parts, not least metal substrates such as gold, silver, aluminium, copper, and electroless nickel; as well as polymeric substrates such as FR4 (a flame resistant composite material composed of woven fibre glass cloth with an epoxy resin binder), nylon, polycarbonate, Lucite (which is polymethylmethacrylate, PMMA), polybutylene terephthalate (PBT), and liquid crystal polymers such as Xydar™, available from Solvay Chemicals, Houston, Tex. 77098 USA.

### EXAMPLES

All viscosity measurements were made using a Modular Compact Rheometer (MCR) 302 from Anton Paar GmbH of Graz, Austria using a 25 mm diameter rotational plate with a gap of 0.3 mm at a shear rate of 1s⁻¹. All viscosities were measured at 25° C. unless otherwise indicated. All mixtures in the Tables are indicated in parts by weight.

Regarding the preparation of component (a), silanol (Si—OH)/Ti molar ratio values given were calculated using the method described above. When vacuum was applied during the process, a vacuum of about 160 mbar (16 kPa) was applied. Where appropriate the mixer lids were pierced with 5 small holes to help the volatile compounds to leave the mixture.

### Example 1

A component (a) titanium-based reaction product was the first prepared. 200 g of dimethylsilanol terminated polydimethylsiloxane having a viscosity of 2,163 mPa·s at 25° C. was introduced into a plastic receptacle of a DAC 600 FVZ/VAC—P type SpeedMixer™ from Hauschild. of tetraisopropoxy titanium were then added into the dimethylsilanol terminated polydimethylsiloxane. A lid was placed on the receptacle and the initial weight of the ingredients, the receptacle and the lid were weighed together.

The ingredients were then mixed in the Hauschild DAC 600 FVZ/VAC-P SpeedMixer™ for 2 minutes at 2350 rpm at atmospheric pressure and then 2 minutes at 2350 rpm under vacuum and then left 6 minutes under vacuum without mixing. This mixing regime was repeated.

After completion of the above mixing regime the SpeedMixer® receptacle, lid and resulting reaction product, were re-weighed to determine weight loss due to the extraction of volatile alcohols. The weight loss was determined to be=0.429 g. The resulting loss of 0.429 g in weight accounted for approximately 100% of the alcohol content extractable as a by-product of the reaction between the first and second ingredients. The calculated Si—OH/Ti molar ratio was about 10.4, assuming a number average molecular weight of the polymer of about 22,000.

The viscosity of the reaction product generated via the above process was determined to be 47,338 mPa·s using a Modular Compact Rheometer (MCR) 302 from Anton Paar GmbH of Graz, Austria using a 25 mm diameter rotational plate with a gap of 0.3 mm at a shear rate of 1s⁻¹.

The titanium-based reaction product was then stored at room temperature in a glass bottle for a period of 28 days before the viscosity was re-measured using the same testing protocol is and was found to have remained pretty constant with a minor increase to 48,856 mPa·s. This was then used as the pat A composition in (Ex. 1a-1c) below.

### Compositions Prepared as Described in Table 1

### Mixing Method

The part B composition was separately prepared in accordance with the compositions indicated in Table 1 below and then the Part A and Part B were then mixed together, in a 1:1 weight ratio for a 30 seconds at 3500 rpm using a SpeedMixer™ DAC 150 FV from Hauschild & Co. KG Germany and subsequently the non-flow time for each sample prepared was determined using the following procedure. Comparative examples were prepared using the compositions indicated and were mixed using the same process.

### Non-Flow Time

For the purpose of these examples, non-flow time was a manual assessment process at room temperature and 50% relative humidity (RH). The values identified in Table 1 were the time at which point the material stops flowing by visual inspection when the container is inclined by 90° (i.e., vertically).

TABLE 1
two-part condensation curable silicone compositions made using the reaction
product of example 1 above (Ex. 1a-1c) and comparatives (C. 1a-1e)

| | Ex. | Ex. | Ex. | C. | C. | C. | C. | C. |
|---|---|---|---|---|---|---|---|---|
| | 1a | 1b | 1c | 1a | 1b | 1c | 1d | 1e |
| Part A | | | | | | | | |
| Ex. 1 reaction product | 100 | 100 | 100 | | | | | 100 |
| OH terminated polydimethylsiloxane | | | | 100 | 100 | 100 | 100 | |
| (viscosity ca 2,163 mPa · s) | | | | | | | | |
| Water | | | | | 0.12 | 0.19 | 0.42 | |
| Part B | | | | | | | | |
| Component (b) 1 | 100 | 100 | 100 | 100 | 100 | 100 | 100 | 100 |
| TiPT | | | | 0.25 | 0.25 | 0.25 | 0.25 | |
| Water | 0.11 | 0.17 | 0.4 | | | | | |
| Non-flow time (min) | 11 | 8 | 5 | 120 | 40 | 32 | 27 | 300 |

In the above Table and hereafter component (b) 1 is Trimethoxysilyl terminated polydimethylsiloxane (viscosity ca 2,000 mPa·s) and TiPT is tetraisopropoxy titanium.

It can be seen that component (a) effectively replaces the standard polymer and catalyst in the composition. It is believed that the chains resulting from the second ingredient are chemically preventing water from hydrolyzing the attacking the titanium molecule, and consequently no additional polymer is required as component (a) the titanium-based reaction product is fully involved in the cure process. Furthermore, it was noticed that the use of component (a) resulted in Examples 1a, 1b, 1c exhibiting a very fast gel time in comparison to the comparative examples.

### Example 2

An alternative component (a) titanium-based reaction product was prepared. 200 g of dimethylsilanol terminated polydimethylsiloxane having a viscosity of 2,163 mPa·s at 25° C. was introduced into a plastic receptacle of a DAC 600 FVZ/VAC—P type SpeedMixer™ from Hauschild. 0.592 g of tetraisopropoxy titanium were then added into the dimethylsilanol terminated polydimethylsiloxane. A lid was placed on the receptacle and the initial weight of the ingredients, the receptacle and the lid were weighed together.

The ingredients were then mixed in a DAC 600 FVZ/VAC—P type SpeedMixer™ from Hauschild for 2 minutes at 2350 rpm at atmospheric pressure and then 2 minutes at 2350 rpm under vacuum and then left 6 minutes under vacuum without mixing. This procedure was then repeated.

After completion of the above mixing regime the resulting reaction product, receptacle and lid were re-weighed to determine weight loss due to the extraction of volatile alcohols. The weight loss was determined to be=0.469 g. The resulting loss of 0.469 g in weight again accounts for approximately 94% of the alcohol content extractable as a by-product of the reaction between the titanate catalyst (the first ingredient) and the polymer (the second ingredient). The calculated Si—OH/Ti molar ratio was about 8.7:1 assuming a number average molecular weight of the polymer of about 22,000.

The viscosity of the titanium-based reaction product generated via the above process was determined to be 211,700 mPa·s using a Modular Compact Rheometer (MCR) 302 from Anton Paar GmbH of Graz, Austria using a 25 mm diameter rotational plate with a gap of 0.3 mm at a shear rate of 1s⁻¹.

The reaction product was then stored at room temperature in a glass bottle for a period of 28 days before the viscosity was re-measured using the same testing protocol is and was found to have remained pretty constant at 208,190 mPa·s.

### Example 3

A further component (a) titanium-based reaction product was prepared. 200 g of dimethylsilanol terminated polydimethylsiloxane having a viscosity of 70 mPa·s at 25° C. was introduced into a plastic receptacle of a DAC 600 FVZ/VAC—P type SpeedMixer™ from Hauschild. 3.5 g of tetraisopropoxy titanium were then added into the dimethylsilanol terminated polydimethylsiloxane. A lid was placed on the receptacle and the initial weight of the ingredients, the receptacle and the lid were weighed together.

The ingredients were then mixed in a DAC 600 FVZ/VAC—P type SpeedMixer™ from Hauschild for 10 minutes at 2350 rpm under vacuum and then this mixing step was undertaken a further seven times.

After completion of the above mixing regime the receptacle, lid and resulting reaction product, were re-weighed to determine weight loss due to the extraction of volatile alcohols. The weight loss was determined to be=2.601 g. The resulting loss of 2.601 g in weight again accounts for approximately 88% of the alcohol content extractable as a by-product of the reaction between the titanate catalyst (the first ingredient) and the polymer (the second ingredient). The calculated Si—OH/Ti molar ratio is about 10.3:1, assuming an average molecular weight of the polymer of about 3,168.

The viscosity of the reaction product generated via the above process was determined to be 617 mPa·s using a Modular Compact Rheometer (MCR) 302 from Anton Paar GmbH of Graz, Austria with a 25 mm diameter rotational plate with a gap of 0.3 mm at a shear rate of 1s⁻¹.

The reaction product was then stored at room temperature in a glass bottle for a period of 28 days before the viscosity was re-measured using the same testing protocol is and was found to have remained pretty constant with a minor increase to 597 mPa·s.

Example 3 is showing that a lower viscosity OH polymer can be used successfully and will lead to a lower viscosity reaction product (a), which can be useful for easy dispensing.

### Example 4

200 g of dimethylsilanol terminated polydimethylsiloxane having an average viscosity of 803 mPa·s at 25° C. was introduced into a plastic receptacle of a DAC 600 FVZ/VAC—P type SpeedMixer™ from Hauschild. 0.8 g of tetraisopropoxy titanium were then added into the dimethylsilanol terminated polydimethylsiloxane. A lid was placed on the receptacle and the initial weight of the ingredients, the receptacle and the lid were weighed together.

The ingredients were then mixed in a DAC 600 FVZ/VAC—P type SpeedMixer™ from Hauschild for 6 minutes at 2350 rpm under vacuum and then this mixing step was repeated a further four times.

After completion of the above mixing regime the resulting reaction product, receptacle and lid were re-weighed to determine weight loss due to the extraction of volatile alcohols. The weight loss was determined to be=0.575 g. The resulting loss of 0.575 g in weight accounts for approximately 85% of the alcohol content extractable as a by-product of the reaction between the titanate catalyst (the first ingredient) and the polymer (the second ingredient). The calculated Si—OH/Ti molar ratio was about 9.6:1 assuming an average molecular weight of the polymer of about 14,800.

The viscosity of the reaction product generated via the above process was determined to be 20,237 mPa·s. The viscosity may be measured using a Modular Compact Rheometer (MCR) 302 from Anton Paar GmbH of Graz, Austria a 25 mm diameter rotational plate with a gap of 0.3 mm at a shear rate of 1s⁻¹.

The titanium-based reaction product was then stored at room temperature in a glass bottle for a period of 28 days before the viscosity was re-measured using the same testing protocol is and was found to have remained pretty constant with an increase to 24,505 mPa·s.

After the viscosity of the aged reaction products was completed, water was added and mixed into the reaction product for 30 second at 3500 rpm using a SpeedMixer™ DAC 150 FV from Hauschild & Co. KG Germany in the amounts indicated in Table 2a. Comparative examples were generated using the same mixing protocol but involved the addition of a standard catalyst where indicated.

TABLE 2a
Part A compositions of two-part condensation curable silicone compositions
containing reaction product of Ex. 4 and comparatives

| | Ex 4a | Ex 4b | C. 4a | C. 4b | C. 4c | C. 4d |
|---|---|---|---|---|---|---|
| Part A | | | | | | |
| Ex. 4 reaction product | 100.4 | 100.4 | | | | |
| OH terminated polydimethylsiloxane | | | 100 | 100 | | |
| (viscosity of 803 mPa · s @ 25° C.) | | | | | | |
| Trimethylsiloxy terminated | | | | | 100 | 100 |
| polydimethylsiloxane (viscosity | | | | | | |
| 1090 mPa · s @ 25° C.) | | | | | | |
| TiPT | | | 0.4 | 0.4 | 0.4 | 0.4 |
| Water | 0 | 0.14 | 0.14* | 0.14** | 0 | 0.14* |
| Measured viscosity initial | 20237 | 20665 | 5495 | 1959 | 3806 | 1265 |
| Measured viscosity after aging | 24505 | 23360 | 1905 | 1482 | 1772 | 1873 |
| for 28D at 25° C. & 50% RH | | | | | | |

In the above Table *indicates the water was added after TiPT and **indicates that water was added before the TiPT.

Table 2a is showing the part A compositions and variation of viscosity between immediate measurements and measurements after aging for 28 days and that the pre-reaction of the polymer with the catalyst is protecting the titanium from both hydrolysis from added water as well as aging for a period of 28 days at 50% relative humidity.

The viscosity variation after 28 days is an indication of the loss of activity of the several comparative examples which use standard titanium catalystswhich are at least partially hydrolysed with water and moisture. Comparative examples C. 4a and C. 4b are showing that the reaction between the first and second ingredients for making component (a) leads to a significant viscosity drop and will lead to a drop of activity which results in longer gel time as indicated in Table 2b below.

The mixtures/reaction products identified from Table 2a were then used in a 1:1 weight ratio with part B, which in this case was component (b) 1 (Trimethoxysilyl terminated polydimethylsiloxane (viscosity ca 2,000 mPa·s)). The part A composition was introduced into one cylinder of a 1:1 mixing unit having side by side cylinders. The other cylinder was filled with Trimethoxysilyl terminated polydimethylsiloxane (viscosity ca 2,000 mPa·s). The material was then extruded through a static mixer and was allowed to cure with the gel time being determined using the following procedure.

### Gel Time

Gel time is defined as the time at which the storage modulus G′ and the loss modulus G″ coincide. The value of G″/G′ is sometimes referred to as tan δ and the gel point is to be understood to be when tan δ=G″/G′=1. The measurements of G′ and G″ were undertaken using the aforementioned Modular Compact Rheometer (MCR) 302 from Anton Paar GmbH of Graz, Austria using a 25 mm diameter rotational plate with a gap of 0.3 mm.

As soon as tan δ is equal to or is less than 1, the curing material is considered to have gelled. Unless otherwise indicated these tests were undertaken at a temperature of 25° C.

The uncured material is placed in the Modular Compact Rheometer between two plates separated by a gap of 0.3 mm. The upper plate was typically 25 mm in diameter and the excess of material is removed with a tissue. A rotary oscillation is carried out at an angular frequency of 10 rad/s and a shear strain of 1%. A measurement is made every 30 seconds initially with a descending logarithmic ramp. For example, after 1500 points, the measurements are carried out every 17.5 min. The gel time is defined as the interval of time between when the product was mixed and when the storage modulus G′ and loss modulus G″ coincide, i.e., when tan δ is equal to or first less than (≤) 1 on the rheometer. This time is roughly equivalent to the time the material under test stops flowing freely.

TABLE 2b
Part B compositions of two-part condensation curable
silicone compositions containing reaction product
of Ex. 4, as seen in Table 2a, and comparatives

| | Ex 4a | Ex 4b | C. 4a | C. 4b | C. 4c | C. 4d |
|---|---|---|---|---|---|---|
| Component (b) 1 | 100 | 100 | 100 | 100 | 100 | 100 |
| (in Wt. %) | | | | | | |
| Mixing Ratio (wt.) | 1:1 | 1:1 | 1:1 | 1:1 | 1:1 | 1:1 |
| Gel time G′/G″ | 30 | 18 | 162 | 232 | 260 | Not curing |
| at 25° C. (min) | | | | | | |

Comparative example C. 4c is showing that the use of a trimethylsiloxy terminated polydimethylsiloxane in place of a silanol terminated polydimethylsiloxane in the part A composition leads to a further loss of activity, while comparative example C. 4d is showing that the titanium catalyst gets totally deactivated if water is added to the mixture, which shows no protective effect of such polymers in comparison with examples 4a and 4b.

### Example 5

A series of examples were prepared using the compositions depicted in Tables 3a (part A) and 3b (part B).

TABLE 3a
Assorted Part A compositions of two-part condensation curable silicone compositions

| Ingredients | Ex. 5a | Ex. 5b | Ex. 5c | Ex. 5d | Ex. 5e | Ex. 5f |
|---|---|---|---|---|---|---|
| OH terminated | 100 | | | | 100 | 100 |
| polydimethylsiloxane | | | | | | |
| (viscosity ca 2,000 mPa · s @ 25° C.) | | | | | | |
| OH terminated | | 100 | 100 | | | |
| polydimethylsiloxane | | | | | | |
| (viscosity ca 13,500 mPa · s @ 25° C.) | | | | | | |
| OH terminated | | | | 100 | | |
| polydimethylsiloxane | | | | | | |
| (viscosity ca 70 mPa · s @ 25° C.) | | | | | | |
| TnBT | 0.3 | | | 1.3 | | |
| TiPT | | 0.075 | 0.075 | | 0.3 | 0.3 |

The following process was used to make the component (a) reaction product for Ex. 5a. The same process was used to prepare the part A compositions of Ex. 5b to Ex. 5f.

200 g of dimethylsilanol terminated polydimethylsiloxane having a viscosity of 2,163 mPa·s at 25° C. was introduced into a plastic receptacle of a DAC 600 FVZ/VAC—P type SpeedMixer™ from Hauschild. 0.51 g of tetra n-butyloxy titanium was then added into the dimethylsilanol terminated polydimethylsiloxane. A lid was placed on the receptacle and the initial weight of the ingredients, the receptacle and the lid were weighed together.

The ingredients were then mixed in a in a DAC 600 FVZ/VAC—P type SpeedMixer™ from Hauschild for 2 minutes at 2350 rpm at atmospheric pressure and then 2 minutes at 2350 rpm under vacuum and then left 6 minutes under vacuum without mixing. This procedure was then repeated for a further 4 times.

After completion of the above mixing regime the resulting reaction product, receptacle and lid were re-weighed to determine weight loss due to the extraction of volatile alcohols. The weight loss was determined to be=0.41 g. The resulting loss of 0.41 g in weight accounts for approximately 95.2% of the alcohol content extractable as a by-product of the reaction between the titanate catalyst (the first ingredient) and the polymer (the second ingredient).

The viscosity of the reaction product generated via the above process was determined to be 54245 mPa·s with an Anton Paar MCR 302 rheometer using a rotational 25 mm plate probe at 25° C. and a shear rate of 1 s⁻¹.

The reaction product was then stored at room temperature in a glass bottle for a period of 28 days before the viscosity was re-measured using the same testing protocol is and was found to have remained pretty constant with a minor increase to 67132 mPa·s.

A part B composition was then prepared as indicated in Table 3b and the resulting part A composition was then mixed and used in the weight ratio indicated in Table 3b with part B, which in this case was component (b) 1 and water added as indicated. The material was then extruded through a static mixer to measure the non-flow time as described above.

TABLE 3b
Assorted Part B compositions of two-part condensation curable
silicone compositions showing enhanced and comparatives

| Ingredients | Ex. 5a | Ex. 5b | Ex. 5c | Ex. 5d | Ex. 5e | Ex. 5f |
|---|---|---|---|---|---|---|
| Part B Mix | 5:1 | 5:1 | 10:1 | 1:1 | 5:1 | 10:1 |
| ratio (weight | | | | | | |
| A:B) | | | | | | |
| Component (b) | 100 | 100 | 100 | 100 | 100 | 100 |
| 1 in wt. %) | | | | | | |
| Water | 0.8 | 0.25 | 0.25 | 0.25 | 0.25 | 0.25 |
| Non flow time | 45 min | 120 min | 120 min | 60 min | 22 min | 180 min |

The cured materials resulting from the compositions prepared formed soft gels that typically cure over a period of 24 hours until the non flow time when cured with standard titanium catalysts such as TiPT and tetra n-butyl titanate (TnBT), but it will be seen that they cure remarkably faster when using component (a) reaction products as described herein.

### Example 6

This example describes the preparation of a component (a) reaction product using the less preferred option of introducing the second ingredient into the first ingredient.

59.088 g of tetra n butoxy titanium was added into a plastic receptacle of a DAC 600 FVZ/VAC—P type SpeedMixer™ from Hauschild. 267.339 g of an OH terminated polydimethylsiloxane (viscosity of 70 mPa·s @ 25° C.) was then added and the mixture was mixed for three 2-minute periods under vacuum at 2300 rpm. 15 g of the resulting component (a) reaction product was mixed with 15 g of trimethoxysilyl terminated polydimethylsiloxane (viscosity ca 2,000 mPa·s @ 25° C.) in a dental mixer at 3500 rpm for 30 seconds. The composition cured with a 30 minute non flow time.

### Example 7

The following example shows two-part compositions as hereinbefore described containing fillers in the preparation of the part A composition.

TABLE 4a
Part A compositions for two-part condensation curable
silicone compositions containing fillers

| Ingredients | | | | |
|---|---|---|---|---|
| Part A | Ex. 7a | Ex. 7b | Ex. 7c | Ex. 7d |
| dimethylsilanol | 100 | 100 | 100 | 100 |
| terminated | | | | |
| polydimethylsiloxane | | | | |
| having a viscosity of | | | | |
| 2,163 mPa · s at 25° C. | | | | |
| TiPT | 0.3 | 0.3 | 0.3 | 0.3 |
| Aerosil ™ R 974 | 16.7 | | | 26.7 |
| Winnofil ™ SPM | | 52.18 | | |
| CAB-O-SIL ™ LM-150 | | | 10 | |

Component (a) was prepared as previously described using the process of Example 1 above and then the respective filler was introduced into the composition.

Aerosil™ R 974 is a hydrophobic fumed silica treated with dimethyldichlorosilanes based on a hydrophilic fumed silica with a specific surface area of 200 m²/g (supplier information) commercially available from Evonik. WINNOFIL™ SPM is an ultrafine coated precipitated calcium carbonate commercially available from Imerys. CAB-O-SIL™ LM-150 is an untreated, low surface area, hydrophilic fumed silica commercially available from the Cabot Corporation.

TABLE 4b
Part B compositions for two-part condensation curable
silicone compositions containing fillers

| Ingredients | Ex. 7a | Ex. 7b | Ex. 7c | Ex. 7d |
|---|---|---|---|---|
| Part B Mix ratio | 1:1 | 1:1 | 1:1 | 1:1 |
| (weight A:B) | | | | |
| Component (b) | 100 | 100 | 100 | 100 |
| 1 in wt. % | | | | |
| Water | 0.23 | 0.23 | 0.23 | 0.23 |
| Non flow time | 10 min | 13 min | 90 min | 20 min |

It can be seen that the compositions cure equally well using a component (a) reaction product as catalyst and polymer in the presence of a suitable filler.

### Example 8

This series of examples and comparatives relies on silane based cross-linkers as part B.

A reaction product (a) was prepared for the following examples shown in Table 5a. 3000 g of dimethylsilanol terminated polydimethylsiloxane having a viscosity of 70 mPa·s at 25° C. was introduced into a Neulinger 5 litre mixer. 53 g of tetraisopropoxy titanium was then added and mixed into the OH terminated polydimethylsiloxane under vacuum using a planetary and disk for 10 minutes at room temperature. Some gelation was observed and therefore the mixture was heated to 100° C. and mixed for a further 4 hours under vacuum. The resulting example 8 reaction product was cooled and stored in a 5-litre plastic pail. It had a viscosity of 1358 mPa·s measured at 25° C.

The example 8 reaction product (a) prepared was then used in the part A compositions for five examples Ex. 8a-e and five comparative examples c. 8a-e.

The part A silicone compositions for Ex. 8a-e were prepared with 101.75 parts by weight e.g., 396.88 g of the example 8 reaction product and 0.8 parts by weight e.g. 3.12 g of water which were mixed together in a DAC 600 FVZ/VAC—P type SpeedMixer™ from Hauschild for 30 seconds at 2350 rpm and stored in two 310 m1 cartridges.

The part A silicone compositions for C. 8a-e were prepared with 390.05 g of OH terminated polydimethylsiloxane having a viscosity of 70 mPa·s @ 25° C. (siloxane 1 in Table 5) was mixed with 3.12 g of water for 30 seconds at 2350 rpm. Then 6.83 g of tetraisopropoxy titanium was added in the mixture and mixed for 30 seconds at 2350 rpm. The preparation was stored in two 310 m1 cartridges.

Examples and comparative examples were made by mixing 30 g of part A with the respective weight of part B as described in the following table so 102.55 parts by weight of part A with the respective part of table 5a. Part A and part B were mixed 30 seconds at 3500 rpm using a SpeedMixer™ DAC 150 FV from Hauschild & Co. KG Germany. The product gel time was determined in the same manner as previously described.

TABLE 5a

| | Ex. 8a & | Ex. 8b & | Ex. 8c & | Ex. 8d & | Ex. 8e & |
|---|---|---|---|---|---|
| Part B | C. 8a | C. 8b | C. 8c | C. 8d | C. 8e |
| methyltrimethoxysilane | 5.5 | | | | |
| Tetraethoxysilane | | 8.6 | | | |
| Acetoxy mix | | | 10 | | |
| n-propyl orthosilicate | | | | 11 | |
| Methyltrioximinosilane | | | | | 12.2 |

Acetoxy mix in Table 5a is a 50/50 by weight mixture of methyl triacetoxysilane and ethyl triacetoxysilane.

The gel times of the respective examples and comparative examples are provided in Tables 5b and 5c below.

TABLE 5b

| | Ex. 8a | Ex. 8b | Ex. 8c | Ex. 8d | Ex. 8e |
|---|---|---|---|---|---|
| Gel time G′/G″ at | 9 | 26 | 29 | 69 | 110 |
| 25° C. (min) | | | | | |

TABLE 5c

| | C. 8a | C. 8b | C. 8c | C. 8d | C. 8e |
|---|---|---|---|---|---|
| Gel time G′/G″ at | 124 | 100 | 100 | 240 | 1500 |
| 25° C. (min) | | | | | |

As it can be seen in the above the examples using component (a) reaction products in part A compositions cause much faster cured products, typically gels in each case using silane cross-linkers.

### Example 9: Partially Trimethylsilyl Terminated OH Terminated PDMS

In this example component (a) was prepared with the first, second and third ingredients. 200 g of a polydimethylsiloxane having 12.5 mol % trimethylsilyl and 87.5 mol % of dimethylsilanol end groups (viscosity of 12,225 mPa·s @ 25° C.) and 0.217 g of tetraisopropoxy titanium was introduced into a plastic receptacle of a DAC 600 FVZ/VAC—P type SpeedMixer™ from Hauschild. A lid was placed on the receptacle and the initial weight of the ingredients, the receptacle and the lid were weighed together. The mixture was mixed in a DAC 600 FVZ/VAC—P type SpeedMixer™ from Hauschild for 4 minutes at 2350 rpm under vacuum and then left 6 minutes under vacuum without mixing. This procedure of mixing was repeated twice.

After completion of the above mixing regime the resulting reaction product, receptacle and lid were re-weighed to determine weight loss due to the extraction of volatile alcohols. The weight loss was determined to be=0.242 g. The resulting loss of 0.41 g in weight accounts for approximately 100% of the alcohol content extractable as a by-product of the reaction between the titanate catalyst (the first ingredient) and the polymer (the second ingredient).

The viscosity of the reaction product generated via the above process was determined to be 69,545 mPa·s with an Anton Paar MCR 302 rheometer using a rotational 25 mm plate probe at 25° C. and a shear rate of 1 s⁻¹.

30 g of here above prepared product was used to make part A of example 8a adding water parts as mentioned in the table here below using a dental mixer for 30s at 3500 rpm. 15 g of the preparation was mixed with 15 g of part B in a dental mixer for 30s at 3500 rpm. The gel time using the same method as previously described was 19 minutes which is much faster than the previously described comparatives.

1. A two-part condensation curable silicone composition comprising:
I) a first part comprising or consisting of:
(a) a titanium-based reaction product obtained or obtainable from a process comprising the steps of:
(i) mixing a first ingredient, an alkoxy titanium compound having from 2 to 4 alkoxy groups with a second ingredient, a linear or branched polydiorganosiloxane polymer having at least two terminal silanol groups per molecule;
(ii) enabling the first and second ingredients to react together by stirring under vacuum to form a reaction product; and
(iii) collecting the reaction product of step (ii); and
II) a second part comprising or consisting of:
(b) one or more silicon containing compounds having at least 2, optionally at least 3, hydroxyl and/or hydrolysable groups per molecule; and wherein either the first part, or the second part, or the first and second parts contains
(c) a source of water comprising water, hydrated reinforcing inorganic filler, hydrated non-reinforcing inorganic filler or a mixture thereof.

2. The two-part condensation curable silicone composition in accordance with claim 1, wherein the first ingredient in the method for the preparation of component (a) is Ti(OR)₄, Ti(OR)₃R¹, Ti(OR)₂R¹₂ or a chelated alkoxy titanium molecule where there are two alkoxy (OR) groups present and a chelate bound twice to the titanium atom; where R is a linear or branched alkyl group having from 1 to 20 carbons and each R¹ may be the same or different and is selected from an alkyl group, an alkenyl group or an alkynyl group in each case having up to 10 carbons.

3. The two-part condensation curable silicone composition in accordance with claim 1, wherein the second ingredient in the method for the preparation of component (a) is a dialkylsilanol terminated polydimethylsiloxane.

4. The two-part condensation curable silicone composition in accordance with claim 1, wherein the second ingredient has a viscosity of between 70 and 20,000 mPa·s at 25° C.

5. The two-part condensation curable silicone composition in accordance with claim 1, wherein the method for the preparation of component (a) utilises a third ingredient, a polydialkylsiloxane having one terminal silanol group per molecule, which is introduced in step (i).

6. The two-part condensation curable silicone composition in accordance with claim 1, wherein component (b) is selected from silanes having at least 2 hydrolysable groups, optionally at least 3 hydrolysable groups per molecule or an organopolysiloxane polymer having at least two hydroxyl or hydrolysable groups per molecule of the formula
X_{3-n′}R³_{n′}Si—(Z)_{d}—(O)_{q}—(R⁴_{y}SiO_{(4-y)/2})_{z}—(SiR⁴₂—Z)_{d}—Si—R³_{n′}X_{3-n′} (7)
in which each X is independently a hydroxyl group or a hydrolysable group, each R³ is an alkyl, alkenyl or aryl group, each R⁴ is an X group, alkyl group, alkenyl group or aryl group and Z is a divalent organic group; d is 0 or 1, q is 0 or 1 and (d+q)=1; n′ is 0, 1, 2 or 3, y is 0, 1 or 2, optionally y is 2, and z is an integer such that the organopolysiloxane polymer has a viscosity of from 50 to 150,000 mPa·s at 25° C.

7. The two-part condensation curable silicone composition in accordance with claim 1, wherein component (c) is water.

8. The two-part condensation curable silicone composition in accordance with claim 7, wherein component (c) is present in a molar ratio of 0.3:1 to 1:1 with respect to the molar content of hydrolysable groups.

9. The two-part condensation curable silicone composition in accordance with claim 1, wherein the first part and/or second part of the composition includes one or more additives selected from the group consisting of anhydrous fillers, adhesion promoters, rheology additive, flux agents, acid acceptors, thermally or electrically conductive additives, salts, dyes, perfumes, preservatives, plasticizers, active ingredients, colorants, labeling agents, rust inhibitors, anti-microbial compounds, detergents, water phase stabilizing agents, pH controlling agents, pigments, colorants, UV absorbers, sunscreen agents, dyes, fragrances or perfume, antioxidants, soil release agents, oxidizing agents, reducing agents, propellant gases, dispersibility aids, inorganic salts, antibacterial agents, antifungal agents, bleaching agents, sequestering agents, enzymes, diluents, and mixtures thereof.

10. The two-part condensation curable silicone composition in accordance with claim 7, wherein component (c) is present in one or other or in both of the first part or second part of the composition.

11. A process for preparing the two-part condensation curable silicone composition in accordance with claim 1, said process comprising:
providing the first part; and
providing the second part.

12. A cured material which is the reaction product of the two-part condensation curable silicone composition in accordance with claim 1.

13. A method of making the cured material in accordance with claim 12, said method comprising mixing the first and second parts together and curing.

14. The process for preparing the two-part condensation curable silicone composition in accordance with claim 11, further comprising mixing the first and second parts together.
